(19) United States
(12) Patent Application Publication
(10) Pub. No.: US 2021/0162692 A1
(43) Pub. Date: Jun. 3, 2021

(54) DIRECT COMPRESSION MOLDED OPHTHALMIC DEVICES

(71) Applicant: Bausch & Lomb Ireland Limited, Dublin (IE)

(72) Inventors: Arvind M. Rao, Rochester, NY (US); Anita M. Graney, Rochester, NY (US); Thomas Jones, Rochester, NY (US); James DiBella, Macedon, NY (US)

(21) Appl. No.: 17/103,298

(22) Filed: Nov. 24, 2020

Related U.S. Application Data
(60) Provisional application No. 62/942,391, filed on Dec. 2, 2019.

(51) Int. Cl. B29D 11/00

(52) U.S. Cl. CPC B29D 11/00519; B29K 2075/00; B29D 11/00067

(57) ABSTRACT

A method for making ophthalmic devices includes direct compression molding one or more ophthalmic device forming polymers in a mold to form ophthalmic devices.

### PRIORITY CLAIM

The present application claims priority to U.S. Provisional Patent Application Ser. No. 62/942,391, entitled “Direct Compression Molded Ophthalmic Devices,” filed Dec. 2, 2019, and incorporated by reference herein in its entirety.

### BACKGROUND

Contact lenses have been manufactured by a variety of methods, including lathing, and cast molding. Lathing is not able to meet the demands of economical, high-volume, and fast production. Efforts to reduce the inherent cost disadvantages of lathing have produced a process that is a hybrid of lathing and cast molding. For example, lenses may be prepared by casting one side of the lens and lathing the other side. This process is less expensive than lathing, but still more expensive than a complete cast molding process.

Cast molding requires the use of two complementary molds. The anterior mold half defines the anterior surface of the lens. The posterior mold half defines the posterior surface of the lens. Mold halves are traditionally used only once and then serve as an element of the packaging for the finished lenses or are discarded. In order to manufacture contact lens mold halves of a desired radius or power, posterior and anterior step tools are used to produce a batch of baseline molds. The baseline molds are measured for accuracy, and a series of step changes must then be made until the desired dimensions are achieved in the resulting mold halves. The desired final lens product determines the design of the necessary posterior and anterior mold halves.

For example, contact lenses are generally cast molded by depositing a curable liquid into a mold cavity defined by two mold halves. These molds are often disposable, and the cost to replace the mold for each new lens is a significant part of the total cost of the final lens. The liquid is then cured within the mold cavity. Following the curing process, the cured lenses are removed from the mold cavity. The lenses will then typically move through other post curing steps to produce a finished lens.

It would be desirable to provide improved methods for making contact lenses that facilitate high volume production of the contact lenses together with the elimination of process steps in the lens manufacture thereby resulting in low per-lens manufacturing costs.

### SUMMARY

In accordance with one exemplary embodiment, a method for making ophthalmic devices is provided comprising direct compression molding one or more ophthalmic device forming polymers in a mold to form an ophthalmic device.

In accordance with one exemplary embodiment, a method for making ophthalmic devices is provided comprising (a) introducing one or more ophthalmic device forming polymers into a mold; and (b) direct compression molding the one or more ophthalmic device forming polymers to form an ophthalmic device.

### BRIEF DESCRIPTION OF THE DRAWINGS

Exemplary embodiments of the present invention will be described below in more detail, with reference to the accompanying drawings, of which:

FIG. 1 illustrates a flow diagram of a current process for making a soft contact lens.

FIG. 2 illustrates a flow diagram of an exemplified direct compression molding process for making soft contact lenses, according to one or more illustrative embodiments.

FIG. 3 illustrates a flow diagram of an exemplified direct compression molding process for making soft contact lenses, according to one or more illustrative embodiments.

FIG. 4 is a perspective view of an anterior surface tool, according to one or more illustrative embodiments.

FIG. 5 is a perspective view of a posterior surface tool, according to one or more illustrative embodiments.

FIG. 6A is a perspective view of a mold assembly, according to one or more illustrative embodiments.

FIG. 6B is a cross-sectional view of the mold assembly of FIG. 6A, according to one or more illustrative embodiments.

FIG. 7 illustrates a contact lens with excess material to be trimmed in a secondary operation, according to one or more illustrative embodiments.

FIG. 8 illustrates a net shape lens, according to one or more illustrative embodiments.

### DETAILED DESCRIPTION

This disclosure relates generally to direct compression molded ophthalmic devices such as soft contact lenses.

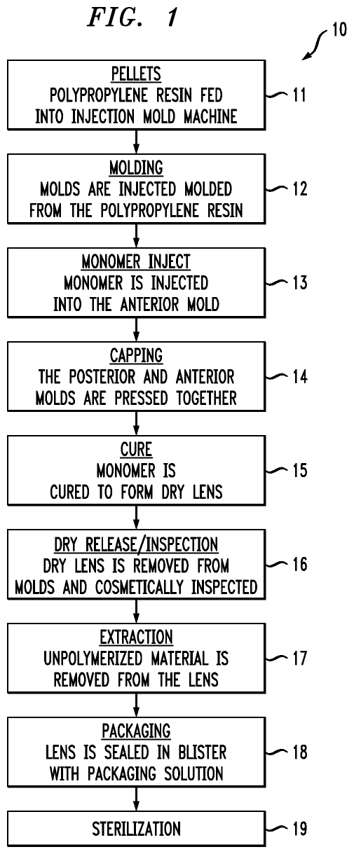

Exemplary embodiments will now be discussed in further detail with regard to direct compression molding of ophthalmic device forming polymers to form ophthalmic devices. The direct compression molding of one or more ophthalmic device forming polymers to form ophthalmic devices such as soft contact lenses advantageously simplifies the existing processes for making ophthalmic devices. For example, FIG. 1 shows a current thermoset cast molding process 10 for making a soft contact lens. An illustrative embodiment shown in the method 10 of FIG. 1 will now be described. In step 11, polypropylene resin is fed into an injection mold machine to form polypropylene pellets. In step 12, the polypropylene pellets are injected molded into anterior and posterior mold halves. In step 13, a monomer mixture is injected into the anterior mold. In step 14, the posterior mold and anterior mold are capped together. In step 15, the monomer mixture is cured under typical curing conditions to form the ophthalmic device. In step 16, the ophthalmic device is inspected for any irregularities or imperfections. In step 17, the unpolymerized material is extracted from the ophthalmic device. In step 18, the ophthalmic device is then packaged in a packaging system. For example, the ophthalmic device is transferred to an individual lens package containing a buffered saline solution containing optional additives as known in the art. Generally, a packaging system for the storage of an ophthalmic device disclosed herein includes at least a sealed container containing one or more of the ophthalmic devices immersed in an aqueous packaging solution. In one embodiment, the sealed container is a hermetically sealed blister-pack, in which a concave well containing the ophthalmic device is covered by a metal or plastic sheet adapted for peeling in order to open the blister-pack. The sealed container may be any suitable generally inert packaging material providing a reasonable degree of protection to the lens, preferably a plastic material such as polyalkylene, PVC, polyamide, and the like. In step 19, the packaged ophthalmic device is then sterilized. Sterilization may take place prior to, or most conveniently after, sealing of the container and may be carried out by any suitable method known in the art, e.g., by steam sterilizing or autoclaving of the sealed container at temperatures of, for example, about 120° C. or higher.

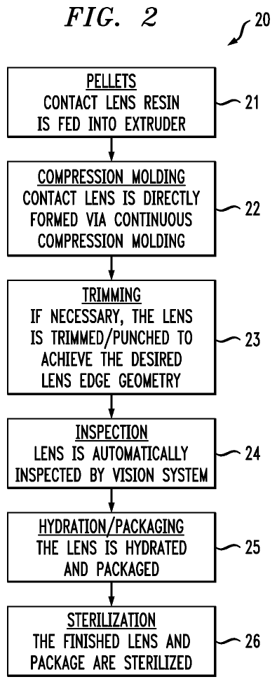

FIG. 2, as described hereinbelow, shows a direct compression molding process for making an ophthalmic device such as a soft contact lens, according to an illustrative embodiment. As can be seen, the process shown in FIG. 2 advantageously eliminates a significant number of process steps as compared to the thermoset cast molding process of FIG. 1.

For example, the direct compression molding process shown in FIG. 2 eliminates the monomer casting requirement into cast molds, curing, demolding and extraction to remove unreacted monomer and other impurities. In addition, direct compression molding of one or more ophthalmic device forming polymers facilitates high volume production of ophthalmic devices for modalities such as daily disposable single use lenses, e.g., in direct compression molding, the lens shape can be produced in about 2 to about 3 seconds and does not require further post processing steps such as extraction prior to hydration and final packaging. This is due to the ophthalmic device forming polymers as discussed below being pre-formed such as a polymer film, a melt pellet and a hot melt prior to introducing it into the mold for direct compression molding into an ophthalmic device. When coupled with a continuous compression molding (CCM) process using, for example, a rotary compression molder, a high production rate can be achieved. In illustrative embodiments, rates from about 500 to about 2000 lenses per minute can be achieved as compared to 100 to 300 lenses per minute for current cast molding processes.

As used herein, the terms “ophthalmic device” and “lens” refer to devices that reside in or on the eye. These devices can provide optical correction, wound care, drug delivery, diagnostic functionality, cosmetic enhancement or any combination of these properties. Representative examples of such devices include, but are not limited to, soft contact lenses, e.g., soft, hydrogel lenses, soft, non-hydrogel lenses and the like, intraocular lenses, overlay lenses, ocular inserts, optical inserts, bandage lenses and therapeutic lenses and the like. As is understood by one skilled in the art, a lens is considered to be “soft” if it can be folded back upon itself without breaking. The ophthalmic devices such as high water content contact lenses of the illustrative embodiments can be spherical, toric, bifocal, and may contain cosmetic tints, opaque cosmetic patterns, combinations thereof and the like.

Suitable ophthalmic device forming polymers for direct compression molding include, for example, hydrophilic thermoplastic polyurethanes (h-TPU) such as aliphatic and aromatic hydrophilic thermoplastic polyurethanes and polyesters, blends of the polyurethanes or polyesters with hydrophobic silicones and/or oligomers or polymers thereof. In illustrative embodiments, the foregoing ophthalmic device forming polymers can exhibit (a) water contents from about 10% to about 90%, or from about 40% to about 80%, (b) a hydrated modulus less than about 100 g/mm², (c) a captive bubble contact angle from about 30°, to about 90°, or less than about 50°, e.g., from about 30 to less than about 50°, (d) visible light transmission from about 65% to about 100%, or greater than about 90% and (e) a refractive index from about 1.35 to about 1.50.

Suitable aliphatic hydrophilic thermoplastic polyurethanes include, for example, those obtained from a reaction product of an aliphatic organic diisocyanate, a hydroxyl-terminated polyol and a low molecular weight glycol (chain extender) in the presence of a catalyst. In general, the polyurethanes are a condensation product of a reaction between one or more diisocyanates and compounds containing active hydrogen sites such as hydroxyl groups. The diisocyanate can be an isocyanate compound having a functionality of two. Examples of suitable aliphatic polyisocyanates include isophorone diisocyanate (IPDI), 1,4-cyclohexyl diisocyanate (CHDI), decane-1,10-diisocyanate, lysine diisocyanate (LDI), 1,4-butane diisocyanate (BDI), 1,5-pentanediisocyanate (PDI), hydrogenated xylene diisocyanate (HXDI), isophorone diisocyanate, hexamethylene diisocyanate (HDI) and dicyclohexylmethane-4,4′-diisocyanate (H12MDI). Mixtures of two or more polyisocyanates may be used. In one embodiment, a suitable diisocyanate is dicyclohexylmethane diisocyanate (HMDI).

Any hydroxyl terminated polyol can be used in herein. Suitable polyols include polyether polyols, polyester polyols, polycarbonate polyols, polysiloxane polyols, and combinations thereof. In one illustrative embodiment, the hydroxyl terminated polyol comprises a polyether polyol. Hydroxyl terminated polyether polyols include polyether polyols derived from a diol or polyol having a total of from 2 to 15 carbon atoms. In some embodiments, hydroxyl terminated polyether polyols include polyether polyols derived from an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG.

Polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THE and ethylene oxide or THE and propylene oxide. These are available from BASF as PolyTHF® B, a block copolymer, and PolyTHF® R, a random copolymer. The various polyether intermediates generally have a number average molecular weight (Mn) as determined by assay of the terminal functional groups which is an average molecular weight greater than about 700, such as from about 700 to about 10,000, or from about 1,000 to about 8,000, or from about 1,400 to about 8,000.

In one embodiment, any high molecular weight polyether polyol available to one of ordinary skill in the art can be used herein. In one embodiment, a high molecular weight polyether polyol is one having an average molecular weight between about 500 and about 5000. In an illustrative embodiment, a suitable high molecular weight polyether polyol is polytetramethylene ether glycol (PTMEG). In an illustrative embodiment, PTMEG has an average molecular weight of about 1000 to about 2000.

Suitable low molecular weight glycols include, for example, lower aliphatic or short chain glycols having from 2 to 20, or 2 to 12, or 2 to 10 carbon atoms. Representative examples of low molecular weight glycols include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof.

One or more polymerization catalysts may be present during the polymerization reaction. Generally, any conventional catalyst can be utilized to react the diisocyanate with the hydroxyl terminated polyol or the chain extender. Examples of suitable catalysts include tertiary amines, e.g. triethylamine, dimethylcyclohexylamine, N-methylmorpholine, N,N′-dimethylpiperazine, 2-(dimethylaminoethoxy)ethanol, diazabicyclo[2.2.2]octane and the like, organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like. The amounts usually used of the catalysts are from 0.0001 to 0.1 part by weight per 100 parts by weight of polyhydroxy compound (b).

In order to prepare a hydrophilic thermoplastic polyurethane, the three reactants (the polyol, the diisocyanate, and the chain extender) may be reacted together to form the hydrophilic thermoplastic polyurethane. Any known processes to react the three reactants may be used to make the TPU. In one embodiment, the process is a so-called “one-shot”process where all three reactants are added to an extruder reactor and reacted. The equivalent weight amount of the diisocyanate to the total equivalent weight amount of the hydroxyl containing components, that is, the polyol intermediate and the chain extender glycol, can be from about 0.95 to about 1.10, or from about 0.96 to about 1.02, and even from about 0.97 to about 1.005. Reaction temperatures utilizing a urethane catalyst can be from about 175 to about 245° C.

The hydrophilic thermoplastic polyurethane can also be prepared utilizing a pre-polymer process. In the pre-polymer route, the polyol is reacted with generally an equivalent excess of one or more diisocyanates to form a pre-polymer solution having free or unreacted diisocyanate therein. The reaction is generally carried out at temperatures of from about 80 to about 220° C. in the presence of a suitable urethane catalyst. Subsequently, a chain extender, as noted above, is added in an equivalent amount generally equal to the isocyanate end groups as well as to any free or unreacted diisocyanate compounds. The overall equivalent ratio of the total diisocyanate to the total equivalent of the polyol intermediate and the chain extender is thus from about 0.95 to about 1.10, or from about 0.96 to about 1.02 and even from about 0.97 to about 1.05. The chain extension reaction temperature is generally from about 180 to about 250° C.

In general, aliphatic hydrophilic thermoplastic polyurethanes for use herein can be those described in, for example, U.S. Pat. No. 4,523,005 and G. Verstraete et. al., “Hydrophilic thermoplastic urethanes for the manufacturing of highly dosed oral sustained release matrices via hot melt extrusion and injection molding,” Int J Pharm., 506 (1-2):214-21) (2016), the contents of which are incorporated by reference herein. These polyurethanes include a soft segment (SS) based on, for example, a polyethylene oxide (PEO) and a hard segment (HS) based on, for example, hexamethylene diisocyanate (HMDI) in combination with 1,4-butanediol (1,4-BD) as a chain extender with a SS/HR ratio greater than about 30, e.g., from about 40 to about 85. In one embodiment, these polyurethanes can exhibit a water content of from about 60 to about 90%. Suitable aliphatic hydrophilic thermoplastic polyurethanes are commercially available under the tradename Tecophilic (Lubrizol Corporation), e.g., Tecophilic TG-500 (also referred to as “TG-500”) and Tecophilic TG-2000 (also referred to as “TG-2000”).

It is also contemplated that h-TPU's with the above or similar hard and soft segments at differing ratios less than 30 can be used that exhibit lower water contents such as from about 5 to about 25. Suitable thermoplastic polyurethanes include those commercially available under the tradename Tecophilic (Lubrizol Corporation). Examples of such h-TPU's include those commercially available under such tradenames as Hydrothane (AdvancSource Biomaterials Corporation), e.g., Hydrothane AL 25-80A that exhibits a water content of 25%.

For the aromatic hydrophilic thermoplastic polyurethanes, suitable aromatic organic diisocyanate compounds that can be used include, for example, methylene diphenyl diisocyanate (MDI), 4,4′-diphenylmethane diisocyanate, p-phenylene diisocyanate, xylene diisocyanate, hexamethylene diisocyanate, isophorone diisocyanate, tolylene diisocyanate, 1,5-naphthalene diisocyanate, and 4,4′-dicyclohexylmethane diisocyanate.

In some illustrative embodiments, these h-TPU's can exhibit haze and translucency when hydrated. To obtain a desired water content and improve their clarity/reduce haze, these TPU's may be melt compounded with other hydrophobic materials and polymers.

In one illustrative embodiment, blends of ophthalmic device forming polymers such as the foregoing h-TPU's with optically clear thermoplastics polymers can be used for forming direct compression ophthalmic devices. Suitable thermoplastics polymers include, for example, polymethyl methacrylate, cyclic olefin polymers, produced by chain copolymerization of cyclic monomers such as 8,9,10-trinorborn-2-ene (norbornene) or 1,2,3,4,4a,5,8,8a-octahydro-1,4:5,8-dimethanonaphthalene (tetracyclododecene) with ethene, e.g., those available under such tradenames as TOPAS (Advanced Polymer) and APEL (Mitsui Chemical), or by ring-opening metathesis polymerization of various cyclic monomers followed by hydrogenation, e.g., those available under such tradenames as ARTON (Japan Synthetic Rubber), and Zeonex and Zeonor (Zeon Chemical) (see, e.g., Pure Appl. Chem., Vol. 77, No. 5, pp. 801-814, (2005), the contents of which are incorporated by reference herein), a cyclic block copolymer comprising a styrenic block copolymer such as styrene-b-butadiene-b-styrene (SBS) and styrene-b-isoprene-b-styrene (SIS) with a hydrogenation level of >99.5% (see, e.g., Inventions 2018, 3(3), 49), the contents of which are incorporated by reference herein), commercially available under the tradename CBC Vivion (USI Corporation, Kaohsiung City, Taiwan), a styrene acrylonitrile commercially available under the tradename Luran (Sryrolution), a polyethylene terephthalate-glycol PET-g commercially available under the tradename Xcel (Artenius) and polylactic acid.

In one illustrative embodiment, blends of ophthalmic device forming polymers such as the foregoing h-TPU's with silicone polymers can be used for forming direct compression ophthalmic devices. Suitable silicone polymers include, for example, polydimethylsiloxane or dimethicone both commercially available from Dow, Momentive or Clearco Products. Representative examples of such polydimethylsiloxanes include PDMS Silicone Oil (Clearco Products) with a viscosity ranging from about 300,000 to about 20,000,000 cSt, Cyclo-1500 Dimethiconol-Cyclopentasiloxane blend and decamethylcyclopentasiloxane silicone oils such as Cyclo-2244, Cyclo-2245 and Cyclo-2345 Cyclomethicone Fluids (Clearco Products).

In one illustrative embodiment, blends of ophthalmic device forming polymers such as the foregoing h-TPU's with silicone-urethane copolymers can be used for forming direct compression ophthalmic devices. Suitable silicone-urethane copolymers include, for example, those commercially available under the tradename PurSil (DSM) and Quadrasil (Biomerics). See, also U.S. Pat. No. 5,589,563, the contents of which are incorporated by reference herein. These are polydimethylsiloxanes incorporated into the polymer soft segment with polytetramethyleneoxide (PTMO) and a hard segment of an aromatic diisocyanate, e.g., 4,4′-methylene-diphenyldiisocyanate (MDI), with a low molecular weight glycol chain extender. The copolymer chains are terminated with silicone or a similar functional group.

In one illustrative embodiment, blends of ophthalmic device forming polymers such as the foregoing h-TPU's with transparent amorphous polyamides can be used for forming direct compression ophthalmic devices. Suitable s amorphous polyamides include, for example, those made from dimethyl terephthalate and trimethylhexamethylene diamine monomers under the tradename Trogamid T (Evonik Industries), and amorphous polyamides made from a cycloaliphatic diamine and 1,12-dodecanedioic acid monomer under the tradename Trogamid CX (Evonik Industries), and amorphous polyamides made from 2,2′-dimethyl-4,4′-methylenebis(cyclohexylamine) and dodecanedioic acid monomers under the tradename EMS Grivory TR from EMS-CHEMIE (Sumter).

In one illustrative embodiment, additional suitable ophthalmic device forming polymers include partially or “lightly” cross-linked thermoplastic. In one embodiment, additional suitable ophthalmic device forming polymers include partially cross-linked TPU's created by thermoplastic vulcanizate (TPV) dynamic vulcanization. Dynamic vulcanization has been applied to the vulcanization of the soft elastomer phase of a blend with rigid thermoplastics. The process is carried out under high shear and above the melting point of the thermoplastic at sufficiently high temperature to activate and complete the vulcanization. See, for example, “The Effect of Dynamic Vulcanization on the Properties of Polypropylene/Ethylene-Propylene Diene Terpolymer/Natural Rubber (PP/EPDM/NR) Ternary Blend,” Halimatuddahliana et. al., Polymer-Plastics Technology and Engineering, Volume 48, 2008—Issue 1.

In one embodiment, additional suitable ophthalmic device forming polymers include partially cross-linked TPU's that are created by electron beam crosslinking.

In one embodiment, additional suitable ophthalmic device forming polymers include partially cross-linked TPU's such as those described in U.S. Pat. No. 4,666,781, the contents of which are incorporated by reference herein. For example, partially cross-linked TPU's can be those linear thermoplastic polyurethane with acrylate side and terminal groups wherein the polyurethane is prepared by reacting poly- and/or diisocyanates with a mixture of (a) methacrylate- or acrylate-diols, (b) monoesters of methacrylic or acrylic acid and a diol and other organic polydiol compounds. In one embodiment, the partially cross-linked TPU's can be prepared by reacting poly- and/or diisocyanates with a mixture of (a) methacrylate- or acrylate-diols having molecular weights of from about 146 to about 3,000, (b) monoesters of methacrylic or acrylic acid and a diol having a molecular weight of from about 116 to about 300, and (c) other organic polydiol compounds which have molecular weights of from about 400 to about 5,000 and differ from (a), with or without (d) diols which differ from (a), diamines, aminoalcohols or triols having molecular weights of from about 61 to about 400, or water, in an NCO/OH ratio of from about 0.9:1 to about 1.1:1, with the proviso that from about 1.4 to about 10 moles of poly and/or diisocyanate, from about 0.1 to about 6 moles of components (a) and (b) and, where relevant, not more than about 9 moles of component (d) are used per mole of component (c).

In one embodiment, additional suitable ophthalmic device forming polymers include partially cross-linked TPU's such as those described in U.S. Pat. No. 6,444,721, the contents of which are incorporated by reference herein. For example, lightly cross-linked TPU's can be those water dispersible radiation curable polyurethane composed essentially of aliphatic polyisocyanates, cycloaliphatic diols and/or diamines, compounds and at least one free-radically polymerizable unsaturated group.

In one embodiment, additional suitable ophthalmic device forming polymers include partially cross-linked TPU's such as those described in U.S. Pat. No. 8,168,260, the contents of which are incorporated by reference herein. For example, partially cross-linked TPU's can include a reaction system comprising (a) a polyfunctional isocyanate; (b) a polyfunctional polyol; (c) a diol chain extender; and (d) a monol or monoamine comprising radically polymerizable unsaturation; or a prepolymer thereof. In one embodiment, the partially cross-linked TPU's can include a modified prepolymer comprising (a) a polyfunctional isocyanate; (b) a polyfunctional polyol; and (c) a monol or monoamine comprising radically polymerizable unsaturation, optionally with a radically polymerizable co-crosslinker. The amount of monol may be such that the molecular weight (MW) (measured as number average Mn) of the final TPU can be comprised of between about 12,000 and about 500,000, or between about 20,000 and about 200,000. The amount of monol is typically from about 0.001 moles/100 g to about 0.016 moles/100 g, or from about 0.002 moles/100 g to about 0.01 moles/100 g of the polymer composition. The monol acts usually as a chain stopper so that the MW can be controlled.

In one illustrative embodiment, other ophthalmic device forming polymers such as hydrophilic thermoplastic materials that can be used herein that form hydrogels include, for example, sulfonated polysulfones (s-PSU), agarose, methylcellulose, hyaluronan and tropoelastin protein.

In direct compression molding, the ophthalmic device forming polymer can be in such forms as, for example, a polymer film, a melt pellet or a hot melt. Each of the forms will be discussed as follows.

Films—a material film can be prepared by the following two methods: (i) film extrusion or (ii) compression molding. In the case of film extrusion, material pellets of the ophthalmic device forming polymers are fed into an extruder and the molten material is forced through a slit die and cooled into a film. In the case of compression molding, material pellets of the ophthalmic device forming polymers are melted at a temperature between about 100 to about 150° C. in a single or twin-screw extruder or co or counter rotating heated kneader (such as a Banbury or Brabender mixer). In this process, the melt is extruded onto a plate, then capped with a second plate and pressed in a heated Carver press at about 135° C. under 7000 psi for approximately 10 minutes to produce a film thickness of about 200 to about 1000 microns. A relatively small portion, for example, approximately 10×10 mm, of this film is then placed onto the bottom cavity of the mold machine. The top cavity is then aligned and pressed down onto the film forming the lens.

Melt pellets—Melt pellets can be prepared by melting the material pellets of the ophthalmic device forming polymers in a single screw extruder and then forced through an orifice that is approximately 25% smaller than the desired diameter of the melt pellet. When the material extrudes from the orifice, a die face knife is used to cut the molten ball of material. In this way a melt pellet is produced and can be delivered into the molding cavity for subsequent compression molding into a lens.

Hot melt—In this process, the material pellets are melted in an extruder or heated cylinder and the melt is then forced through an orifice approximately about 0.1 to about 2 mm in diameter (preferably about 0.5 to about. 1 mm in diameter) using either a piston or compressed air. This produces a small melt bead that is directly dropped or sprayed onto the mold cavity followed by subsequent compression molding into a lens.

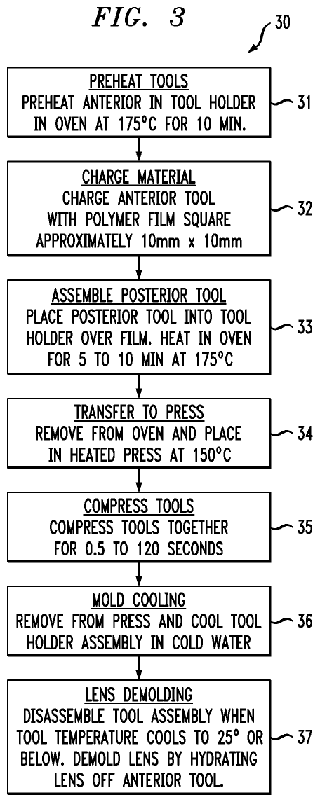

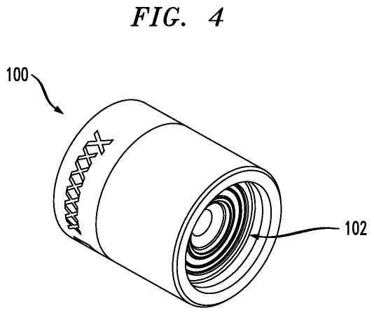

In general, direct compression molding of ophthalmic devices such as soft contact lenses involves one or more ophthalmic device forming polymers such as hydrophilic thermoplastic melt processable polymers, mold tooling, heat and compression of the mold tools (see, FIGS. 4-6B). In one illustrative embodiment, a direct compression molding process 30 as illustrated in FIG. 3, involves, in steps 31 and 32, charging a preheated concave (or anterior) metal compression mold half with one or more of polymer pellets, films or polymer melts as discussed above. In step 33, the concave (or anterior) metal compression mold half is capped with a convex (or posterior) metal compression mold half in a vertical axis. In an alternative embodiment, the step of charging can be reversed or conducted in a horizontal axis. Optical mold tooling can be designed as either net shape or contain features that create additional materials around the perimeter of the lens that can be subsequently trimmed in a secondary process.

In one embodiment, a heated mold assembly comprising a concave metal compression mold half, one or more ophthalmic device forming polymers such as a hydrophilic thermoplastic melt processable polymer(s) and a convex metal compression mold half can be compressed under pressure for a time period ranging from about 0.5 seconds to about 5 minutes as shown in steps 34 and 35. In another embodiment, a heated mold assembly comprising a concave metal compression mold half, one or more ophthalmic device forming polymers such as a hydrophilic thermoplastic melt processable polymer(s) and a convex metal compression mold half can be compressed under pressure for a time period ranging from about 30 seconds to about 120 seconds. In general, the mold assembly can be heated to a temperature ranging from about 50 to about 200° C. In one embodiment, the mold assembly can be heated to a temperature ranging from about 120 to about 150° C. Next, the mold assembly can be cooled in step 36, and then subsequently separated in step 37. The finished shape or device is extracted by, for example, hydrating the lens off the anterior mold half. Hydration of the device such as a contact lens results in a soft contact lens. This lens has the advantage that it does not require any extraction and may be directly hydrated prior to packaging.

Suitable tooling for the direct compression molding process of the one or more ophthalmic device forming polymers include, for example, optical mold tooling with a surface roughness (Ra or RMS) less than about 100 nanometers with tools forming the posterior and anterior surfaces simultaneously. Representative examples of mold tooling used in a compression molding process include (i) a single cavity-core tooling compressed in a heated press, (ii) a multi-cavity tooling compressed in a heated press and (iii) a rotary continuous compression molding machine (CCM) such as those manufactured by SACMI.

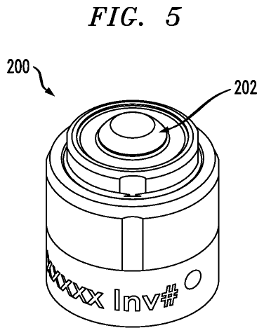

A representative mold tool assembly for compression molding of ophthalmic devices such as contact lenses according to illustrative embodiments herein is shown in FIGS. 4 to 6B. In general, a mold tool assembly includes a first mold tool section and a second mold tool section. As shown in FIG. 4, a first mold tool section includes an anterior metal compression mold half 100 without or without a lens trim feature (not shown) and having a concave surface. The anterior metal compression mold half 100 includes an optical quality anterior lens-molding surface 102 for forming the contact lens anterior surface. As shown in FIG. 5, the second mold tool section includes a posterior metal compression mold half 200 having a convex surface. The posterior metal compression mold half 200 includes an optical quality posterior lens-molding surface 202 for forming the contact lens posterior surface. The anterior metal compression mold half 100 and posterior metal compression mold half 200 can be formed of, for example, a copper-based alloy or steel. In addition, as one skilled in the art will readily appreciate, the mold cavity surface, i.e., when the mold sections are fully assembled, a lens-forming cavity (not shown) is defined between lens-molding surfaces, for each of the anterior metal compression mold half 100 and the posterior metal compression mold half 200 can be plated with a ceramic coating material such as a DLC (diamond-like coating) to assist in releasing the resulting ophthalmic device from the mold assembly.

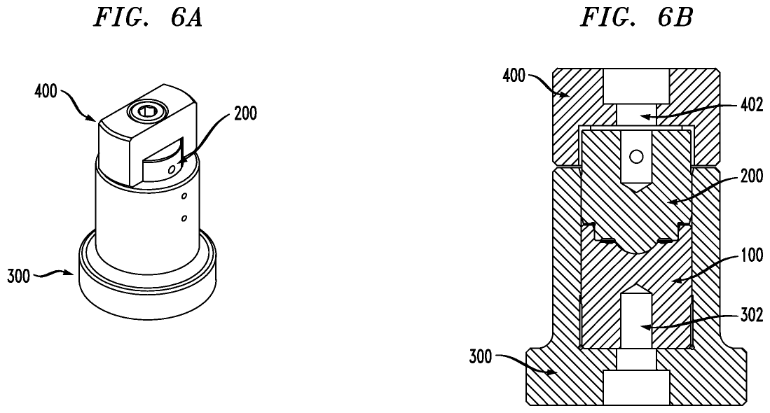

As shown in FIGS. 6A and 6B, in operation, the bottom portion of anterior metal compression mold half 100 is placed in tool holder 300 such that optical quality anterior lens-molding surface 102 is face up. For example, anterior metal compression mold half 100 can be operatively connected to tool holder 300 by way of, for example, screw 302. However, as one skilled in the art will appreciate, other ways to operatively connect anterior metal compression mold half 100 to tool holder 300 are contemplated. Posterior metal compression mold half 200 is then operatively connected to anterior metal compression mold half 100 such that optical quality posterior lens-molding surface 202 is disposed in the opening in optical quality anterior lens-molding surface 102 defining a lens-forming cavity. Prior to operatively connecting posterior metal compression mold half 200 with anterior metal compression mold half 100, the ophthalmic device forming polymers in the form of a substantially thermoplastic polymer film, melt pellet or hot melt as discussed above is disposed in the opening defining optical quality anterior lens-molding surface 102 of anterior metal compression mold half 100 in tool holder 300. This is one illustrative embodiment and other embodiments for connecting posterior metal compression mold half 200 with anterior metal compression mold half 100, and introducing the one or more ophthalmic device forming polymers into the assembly are contemplated.

Once assembled, posterior metal compression mold half 200 and anterior metal compression mold half 100 are aligned. The mold assembly is then compressed for a time period sufficient to form an ophthalmic device as discussed above. After the compression is completed, extraction tool 400 is placed over posterior metal compression mold half 200 and screw 402 is turned until the posterior metal compression mold half 200 is separated from anterior metal compression mold half 100. Next, the resulting ophthalmic device is removed from the anterior metal compression mold half 100 by, for example, hydrating the ophthalmic device with water or a suitable solution and removing it by tweezers.

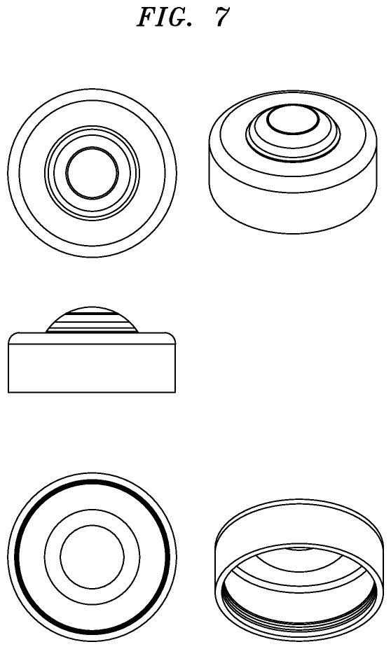

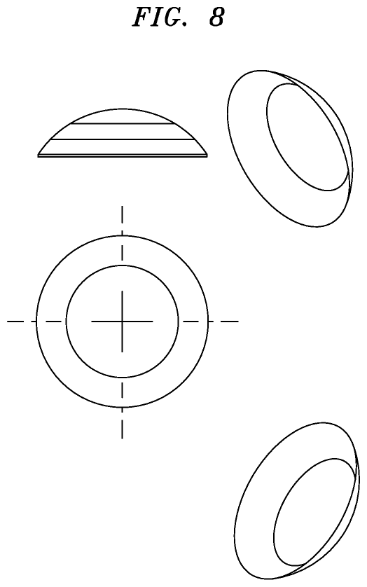

The foregoing tool assembly can produce, for example, a +3.00 hydrated SVS lens with an 8.5 Base Curve, a center thickness of 160 microns, a nominal lens sag of 3.987 mm and a knife edge profile. In an illustrative embodiment, based on the anterior surface tool, a lens with extra material around the lens perimeter can be produced (see, FIG. 7) which can be trimmed in a secondary operation, or a net shape lens can be produced (see, FIG. 8).

An illustrative embodiment shown in the method 20 of FIG. 2 will now be described. In step 21, the one or more ophthalmic device forming polymers are fed into an extruder to form pellets. In step 22, the pellets are introduced into a mold and subjected to continuous direct compression molding to form ophthalmic devices. In step 23, each ophthalmic device is optionally trimmed/punched to achieve a desired edge geometry. In step 24, each ophthalmic device is inspected for any irregularities or imperfections. In step 25, if the ophthalmic device passes inspection it is then hydrated, removed from the assembly and packaged in a packaging system. For example, the ophthalmic device is transferred to an individual lens package containing a buffered saline solution containing optional additives as known in the art. Generally, a packaging system for the storage of an ophthalmic device disclosed herein includes at least a sealed container containing one or more of the ophthalmic devices immersed in an aqueous packaging solution. In one embodiment, the sealed container is a hermetically sealed blister-pack, in which a concave well containing the ophthalmic device is covered by a metal or plastic sheet adapted for peeling in order to open the blister-pack. The sealed container may be any suitable generally inert packaging material providing a reasonable degree of protection to the lens, preferably a plastic material such as polyalkylene, PVC, polyamide, and the like. Any known buffered saline solution can be used herein. In step 26, the packaged ophthalmic device is then sterilized. Sterilization may take place prior to, or most conveniently after, sealing of the container and may be carried out by any suitable method known in the art, e.g., by steam sterilizing or autoclaving of the sealed container at temperatures of, for example, about 120° C. or higher.

The following examples are provided to enable one skilled in the art to practice the invention and are merely illustrative. The examples should not be read as limiting the scope of the invention as defined in the claims.

Various lenses were formed as discussed below and may be characterized by standard testing procedures such as:

Water %: Two sets of six hydrated lenses or films are blotted dry on a piece of filter paper to remove excess water, and samples are weighed (wet weight). Samples are then placed in a microwave oven for 10 minutes inside ajar containing desiccant. The samples are then allowed to sit for 30 minutes to equilibrate to room temperature and reweighed (dry weight). The percent water is calculated from the wet and dry weights.

Contact Angle (CBCA): Captive bubble contact angle data was collected on a First Ten Angstroms FTA-1000 drop Shape Instrument. All samples were rinsed in HPLC grade water prior to analysis in order to remove components of the packaging solution from the sample surface. Prior to data collection, the surface tension of the water used for all experiments was measured using the pendant drop method. In order for the water to qualify as appropriate for use, a surface tension value of 70 to 72 dynes/cm was expected. All lens samples were placed onto a curved sample holder and submerged into a quartz cell filled with HPLC grade water. Advancing and receding captive bubble contact angles were collected for each sample. The advancing contact angle is defined as the angle measured in water as the air bubble is retracting from the lens surface (water is advancing across the surface). All captive bubble data was collected using a high-speed digital camera focused onto the sample/air bubble interface. The contact angle was calculated at the digital frame just prior to contact line movement across the sample/air bubble interface. The receding contact angle is defined as the angle measured in water as the air bubble is expanding across the sample surface (water is receding from the surface).

### Example 1

A compression molded lens was prepared by a single net shape cavity-core tooling compressed in a heated press. The concave anterior, convex posterior and tool holder were heated in an oven at 175° C. for 10 minutes. A Tecophilic TG-500 (Lubrizol Life Science, Brecksville, Ohio) film approximately 10×10 mm square and 100 microns thick, prepared as discussed hereinabove, was charged on the concave anterior tool held in a tool holder that served to hold and align the posterior tool over the anterior tool. The posterior tool was assembled over the anterior tool in the tool holder. This assembly was heated in an oven for 5 minutes at 175° C. The assembly was removed from the oven and immediately placed in a press whose platens have been heated to 150° C. The assembly was compressed for 30 seconds, and then the assembly was removed from the press and cooled in a water bath to 28° C. Next, the posterior tool was removed, and the finished lens was extracted using tweezers from the anterior tool. The lens was hydrated in a borate buffer solution. The lens properties such as power, center thickness and diameter were measured as set forth below in Table 1.

### Example 2

A compression molded lens was prepared by a single net shape cavity-core tooling compressed in a heated press. The concave anterior, convex posterior and tool holder were heated in an oven at 175° C. for 10 minutes. A TG-500 film approximately 10×10 mm square and 100 microns thick, prepared as discussed hereinabove, was charged on the concave anterior tool held in a tool holder that served to hold and align the posterior tool over the anterior tool. The posterior tool was assembled over the anterior tool in the tool holder. This assembly was heated in an oven for 10 minutes at 175° C. The assembly was removed from the oven and immediately placed in a press whose platens have been heated to 150° C. The assembly was compressed for 60 seconds, and then removed from the press and cooled in a water bath to 23° C. Next, the posterior tool was removed, and the finished lens was hydrated with distilled water and extracted with tweezers. The lens was hydrated in a borate buffer solution. The lens properties such as power, center thickness and diameter were measured as set forth below in Table 1.

### Example 3

A compression molded lens was prepared by a single net shape cavity-core tooling compressed in a heated press. The concave anterior, convex posterior and tool holder are heated in an oven at 175° C. for 10 minutes. A TG-500 film approximately 10×10 mm square and 100 microns thick, prepared as discussed hereinabove, was charged on the concave anterior tool held in a tool holder that served to hold and align the posterior tool over the anterior tool. The posterior tool was assembled over the anterior tool in the tool holder. This assembly was heated in an oven for 10 minutes at 175° C. The assembly was removed from the oven and immediately placed in a press whose platens have been heated to 150° C. The assembly was compressed for 120 seconds, and then removed from the press and cooled in a water bath to 27° C. Next, the posterior tool was removed, and the finished lens was hydrated with distilled water and extracted with tweezers. The lens was hydrated in a borate buffer solution. The lens properties such as power, center thickness and diameter are set forth below in Table 1.

TABLE 1

| | Example 1 | Example 2 | Example 3 |
|---|---|---|---|
| Material | Tecophilic TG-500 | Tecophilic TG-500 | Tecophilic TG-500 |
| Material Form | 100 μm film | 100 μm film | 100 μm film |
| Tooling | Net shape tool | Net shape tool | Net shape tool |
| Lens Type | SVS | SVS | SVS |
| Aim Power (D) | +3.00 | +3.00 | +3.00 |
| Actual Power¹ (D) | +3.25 | +2.75 | +2.75 |
| Diameter² | 14.200/>15 | 14.200/>15 | 14.200/>15 |
| Aim/Actual (mm) | | | |
| Center Thickness | 0.160/0.187 | 0.160/0.144 | 0.160/0.156 |
| Aim/Actual (mm) | | | |

¹Vertexometer Power - 15 mm paddle used.
²Diameter inferred based on 15 mm paddle used for the Vertexometer measurement.

### Example 4

A compression molded lens was prepared by a single net shape cavity-core tooling compressed in a heated press. The concave anterior, convex posterior and tool holder were heated in an oven at 160 to 175° C. for 10 minutes. A Tecophilic TG-500 film approximately 10×10 mm square and 100 microns thick, prepared as described hereinabove, was charged on the concave or anterior tool held in a tool holder that served to hold and align the posterior tool over the anterior tool. The posterior tool was assembled over the anterior tool in the tool holder. This assembly was heated in an oven for 10 minutes at 160 to 175° C. The assembly was removed from the oven and immediately placed in a press whose platens were heated to 150° C. The assembly was compressed for 60 seconds, and then removed from the press and cooled in a water bath to 25° C. Next, the posterior tool was removed, and the finished lens was hydrated with distilled water and extracted with tweezers. The lens was then hydrated in a borate buffer solution. The lens properties such as power, center thickness and diameter were measured as set forth below in Table 2. Three lenses were prepared by this method.

### Example 5

A compression molded lens was prepared by a single net shape cavity-core tooling compressed in a heated press. The concave anterior, convex posterior and tool holder were heated in an oven at 160 to 175° C. for 10 minutes. A Tecophilic TG-500 plus+20% Hydrothane AL 25-80A (elastomeric hydrophilic TPU with an 80 Shore A hardness, 25% water content from AdvancSource Biomaterials Corporation, Wilmington, Mass.) film, prepared as described hereinabove, was charged on the concave or anterior tool held in a tool holder that served to hold and align the posterior tool over the anterior tool. The posterior tool was assembled over the anterior tool in the tool holder. This assembly was heated in an oven for 10 minutes at 160 to 175° C. The assembly was removed from the oven and immediately placed in a press whose platens were heated to 150° C. The assembly was compressed for 60 seconds, and then removed from the press and cooled in a water bath to 25° C. Next, the posterior tool was removed, and the finished lens was hydrated with distilled water and extracted with tweezers. The lens was then hydrated in a borate buffer solution. The film thickness and lens properties such as power, center thickness and diameter are set forth below in Table 2. Three lenses were prepared by this method.

TABLE 2

| | Example 4 | Example 5 |
|---|---|---|
| Material | Tecophilic TG-500 | Tecophilic TG-500 + 20% |
| | | AdvanSource Hydrothane AL 25-80A |
| Material Form | 327 μm film | 293 μm film |
| Tooling | Net shape tool | Net shape tool |
| Lens Type | SVS | SVS |
| Aim Power (D) | +3.00 | +3.00 |
| Power¹ (D)/St. Dev. | +2.75 (—) | +2.67 (0.29) |
| Image quality | Fair | Good |
| Diameter² Aim/Actual | 14.200/>15 | 14.200/>15 |
| (mm) | | |
| Center Thickness | 0.160/0.157 | 0.160/0.154 |
| Aim/Actual (mm) | (0.001) | (0.006) |
| Water Content (%) | 78.4 | 73.1 |
| X-Y Expansion factor | 1.83 | 1.67 |

¹Vertexometer Power - 15 mm paddle used.
²Diameter inferred based on 15 mm paddle used for the Vertexometer measurement.

### Examples 6-9

A compression molded lens was prepared by a single net shape cavity-core tooling compressed in a heated press. The concave anterior, convex posterior and tool holder were heated in an oven at 160 to 175° C. for 10 minutes. The films, prepared as described hereinabove, were charged on the concave or anterior tool held in a tool holder that served to hold and align the posterior tool over the anterior tool. The posterior tool was assembled over the anterior tool in the tool holder. This assembly was heated in an oven for 10 minutes at 160 to 175° C. The assembly was removed from the oven and immediately placed in a press whose platens were heated to 150° C. The assembly was compressed for 60 seconds, and then removed from the press and cooled in a water bath to 25° C. Next, the posterior tool was removed, and the finished lens was hydrated with distilled water and extracted with tweezers. The lens was then hydrated in a borate buffer solution. The film thickness and lens properties such as power, center thickness and diameter are set forth below in Table 3. A minimum of three lenses for each material were prepared by this method.

Visual inspection of these lenses showed that although the lenses were fully formed, they contained inclusions or voids as a result of the forming process. These voids did not detour from the lens properties and further lens edge section revealed that the lens edge thickness met the expected nominal and edge shape was fully formed. Additionally, lens stress profiles indicated that the lens did not contain any stress and were formed with the correct shape.

TABLE 3

| | Comp. | | | | |
|---|---|---|---|---|---|
| | Ex. 1¹ | Ex. 6 | Ex. 7 | Ex. 8 | Ex, 9 |
| Lens making | Cast | Compression | Compression | Compression | Compression |
| process | Molded | Molding | Molding | Molding | Molding |
| Material | Samfilcon | Tecophilic | Tecophilic | Tecophilic TG- | Tecophilic TG- |
| | A | TG-500 | TG-500 | 500 + 20% | 500 + 20% |
| | | | | AdvanSource | AdvanSource |
| | | | | Hydrothane AL | Hydrothane AL |
| | | | | 25-80A | 25-80A |
| Material Form | Liquid | 257 μm | 293 μm | 320 μm | 257 μm |
| | Monomer | film | film | film | film |
| Tooling | Net shape | Net shape | Net shape | Net shape | Net shape |
| | PP mold | tool | tool | tool | tool |
| Lens Type | SVS | SVS | SVS | SVS | SVS |
| Aim Power (D) | +3.00 | +3.00 | +3.00 | +3.00 | +3.00 |
| Power² (D)/St. Dev. | +3.00 | +2.73 | +2.67 | +2.84 | +2.88 |
| | (0.02) | (0.25) | (0.29) | (0.12) | (0.13) |
| Image quality | Good | Fair | Fair | Fair | Fair |
| Diameter³ | 14.200 14.240 | 14.200/>15 | 14.200/>15 | 14.200/>15 | 14.200/>15 |
| Aim/Actual (mm) | (0.020) | | | | |
| Center Thickness | 0.180 0.179 | 0.160/0.158 | 0.160/0.154 | 0.160/0.149 | 0.160/0.151 |
| Aim/Actual (mm) | (0.0004) | (0.005) | (0.006) | (0.001) | (0.004) |
| Water Content | 45.8 | 78.4 | — | 73.1 | — |
| (%) | | | | | |
| CBCA (°) | 33 | 46 | 45 | 44 | 47 |
| | (0.6) | (0.6) | (1.0) | (0.7) | (2.9) |
| Modulus, | 74 | 57 | 60 | 59 | 83 |
| (g/mm²) | | | | | |

¹Average of 10 production lots.
²Vertexometer Power - 15 mm paddle used.
³Diameter inferred based on 15 mm paddle used for the Vertexometer measurement.

### Examples 10 and 11

A compression molded lens was prepared by a single net shape cavity-core tooling compressed in a heated press. The concave anterior, convex posterior and tool holder were heated in an oven at 160 to 175° C. for 10 minutes. The films (TG-500+20% USI Vivion CBC 8210 (a cyclic block copolymer consisting of a styrenic block copolymer such as styrene-b-butadiene-b-styrene (SBS) and styrene-b-isoprene-b-styrene (SIS) with a hydrogenation level of >99.5% (USI Corporation, Kaohsiung City, Taiwan) for Example 10 and TG-500+2% Cyclo-1500 Dimethiconol-Cyclopentasiloxane Blend (Cylco-1500 blend) which is a blend containing 75 to 95% Decamethylcyclopentasiloxane and 5 to 25% hydroxyl-terminated Dimethylpolysiloxane (Clearco Products, Bensalem, Pa.) for Example 11), prepared as described hereinabove, were charged on the concave or anterior tool held in a tool holder that served to hold and align the posterior tool over the anterior tool. The posterior tool was assembled over the anterior tool in the tool holder. This assembly was heated in an oven for 10 minutes at 160 to 175° C. The assembly was removed from the oven and immediately placed in a press whose platens were heated to 150° C. The assembly was compressed for 60 seconds, and then removed from the press and cooled in a water bath to 25° C. Next, the posterior tool was removed, and the finished lens was hydrated with distilled water and extracted with tweezers. The lens was then hydrated in a borate buffer solution. The film thickness and lens properties such as power, center thickness and diameter are set forth below in Table 4. Three lenses for each material were prepared by this method.

TABLE 4

| | Example 10 | Example 11 |
|---|---|---|
| Material | TG-500 + 20% | TG-500 + 2% |
| | USI CBC 8210 | Cylco-1500 blend |
| Material Form | 335 μm film | 293 μm film |
| Tooling | Net shape tool | Net shape tool |
| Lens Type | SVS | SVS |
| Aim Power (D) | +3.00 | +3.00 |
| Power¹ (D)/St. Dev. | NR² | +2.75 (0.0) |
| Image quality | — | Poor-Fair |
| Diameter³ Aim/Actual (mm) | 14.200/>15 | 14.200/>15 |
| Center Thickness | 0.160/NT⁴ | 0.160/0.156 |
| Aim/Actual (mm) | | (0.006) |
| Water Content (%) | 78.4 | 78.6 |
| X-Y expansion factor | 1.68 | 1.73 |

¹Vertexometer Power - 15 mm paddle used.
²No reading from Vertexometer for power measurement
³Diameter inferred based on 15 mm paddle used for the Vertexometer measurement.
⁴Not tested

### Example 12

In this example, the initial tool pre-heat step was not carried out and the material films were placed on the anterior tool and directly heated in an oven with the tooling. The films, approximately 10×10 mm square, were charged on the concave or anterior tool held in a tool holder that served to hold and align the posterior tool over the anterior tool. The posterior tool was assembled over the anterior tool in the tool holder. This assembly was heated in an oven for 10 minutes at 175° C. The assembly was removed from the oven and immediately placed in an unheated press (as opposed to heated platens in the above examples). The assembly was compressed for 50 seconds, and then removed from the press and cooled in a water bath to 25° C. in 3 minutes. Next, the posterior tool was removed, and the finished lens was hydrated with distilled water and then extracted with tweezers. The lens was hydrated in a borate buffer solution. The lens properties such as center thickness and diameter were measured as set forth below in Table 5. Three lenses for each material were prepared by this method.

Preparation of contact lenses by this modified method showed significant reduction or elimination of voids and excellent replication of the expected lens dimensions such as mid-peripheral thickness (MPT) and edge thickness. It was also noted that this method did not require the initial film thickness to be of a specific thickness. In the initial process, a film thickness between 100 to 400 microns was used to produce a satisfactory lens. In this process, a film thickness up to 1000 microns or 1 mm can be used.

TABLE 5

| | Example 12 |
|---|---|
| Material | TG-500 |
| Material Form | Thick film |
| Tooling | Net shape tool |
| Lens Type | SVS |
| Aim Power (D) | +3.00 |
| Diameter¹ Aim/Actual (mm) | 14.200/16.272 |
| Edge thickness | 0.100/0.099 |
| Aim/Actual (mm) | (0.008) |
| Mid Peripheral Thickness | 0.161/0.159 |
| | (0.012) |

¹Diameter inferred based on 15 mm paddle used for the Vertexometer measurement.

### Example 13

A compression molded lens shape was prepared by a single cavity continuous compression molding machine (CMM) manufactured by SACMI (Imola, Italy). In this process, melt pellets are introduced into a cavity-core assembly or stack every 3.5 seconds. The melt pellet with a mass of 0.30 grams were prepared by extruding the h-TPU through a vertical orifice with a nozzle melt temperature of 130° C. and delivered to the cavity-core assembly with the cavity heated to a temperature between 15 and 35° C. and the core heated to between 15 and 60° C. The assembly contained the optical tooling that was designed to produce a +6.00 hydrated SVS lens with an 8.5 Base Curve, a CT of 220 microns, a nominal lens sag of 4.047 mm and a knife edge profile. The optical tooling produced a lens shape contained within a cap (see, FIG. 7). Upon ejection and cooling, the excess material is trimmed by a secondary operation resulting in a lens shape.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A method for making ophthalmic devices comprising direct compression molding one or more ophthalmic device forming polymers in a mold to form an ophthalmic device.

2. The method of claim 1, wherein the mold comprises a posterior mold section having a molding surface shaped to provide a posterior ophthalmic device surface and an anterior mold section having a molding surface shaped to provide an anterior ophthalmic device surface.

3. The method of claim 2, comprising placing the one or more ophthalmic device forming polymers in the anterior mold section and capping the anterior mold section with the posterior mold section.

4. The method of claim 3, further comprising de-capping the anterior mold section from the posterior mold section and releasing the ophthalmic device from either the anterior mold section or the posterior mold section.

5. The method of claim 1, wherein the direct compression molding is a continuous direct compression molding.

6. The method of claim 1, wherein the one or more ophthalmic device forming polymers comprise one or more of an aliphatic hydrophilic thermoplastic polyurethane, an aromatic hydrophilic thermoplastic polyurethane, an aliphatic hydrophilic thermoplastic polyester, an aromatic hydrophilic thermoplastic polyester, and a blend of one or more of the aliphatic hydrophilic thermoplastic polyurethane, the aromatic hydrophilic thermoplastic polyurethane, the aliphatic hydrophilic thermoplastic polyester, the aromatic hydrophilic thermoplastic polyester with a hydrophobic silicone.

7. The method of claim 6, wherein the aliphatic hydrophilic thermoplastic polyurethane comprises a reaction product of an aliphatic organic diisocyanate, a polyether polyol and a chain extender.

8. The method of claim 1, wherein the one or more ophthalmic device forming polymers comprise a blend of the one or more ophthalmic device forming polymers and one or more silicone polymers.

9. The method of claim 8, wherein the one or more silicone polymers include polydimethylsiloxane, dimethicone or both.

10. The method of claim 1, wherein the one or more ophthalmic device forming polymers comprise a blend of the one or more ophthalmic device forming polymers and one or more silicone-urethane copolymers.

11. The method of claim 1, wherein the one or more ophthalmic device forming polymers comprise one of a polymer film, a melt pellet and a hot melt.

12. The method of claim 1, comprising:
(a) introducing the one or more ophthalmic device forming polymers into an anterior mold section;
(b) capping the anterior mold section with a posterior mold section mold; and
(c) direct compression molding the one or more ophthalmic device forming polymers to form an ophthalmic device.

13. The method of claim 12, wherein the one or more ophthalmic device forming polymers comprise one of a polymer film, a melt pellet and a hot melt.

14. The method of claim 13, wherein the one of a polymer film, a melt pellet and a hot melt comprises one or more of an aliphatic hydrophilic thermoplastic polyurethane, an aromatic hydrophilic thermoplastic polyurethane, an aliphatic hydrophilic thermoplastic polyester, an aromatic hydrophilic thermoplastic polyester, and a blend of one or more of the aliphatic hydrophilic thermoplastic polyurethane, the aromatic hydrophilic thermoplastic polyurethane, the aliphatic hydrophilic thermoplastic polyester, the aromatic hydrophilic thermoplastic polyester with a hydrophobic silicone.

15. The method of claim 14, wherein the aliphatic hydrophilic thermoplastic polyurethane comprises a reaction product of an aliphatic organic diisocyanate, a polyether polyol and a chain extender.

16. The method of claim 13, wherein the one of a polymer film, a melt pellet and a hot melt comprises a blend of one or more ophthalmic device forming polymers and one or more silicone polymers.

17. The method of claim 16, wherein the one or more silicone polymers include polydimethylsiloxane, dimethicone or both.

18. The method of claim 13, wherein the one of a polymer film, a melt pellet and a hot melt comprise a blend of the one or more ophthalmic device forming polymers and one or more silicone-urethane copolymers.

19. The method of claim 1, wherein the ophthalmic device is a contact lens.

20. The method of claim 19, further comprising hydrating the contact lens to form a soft contact lens.
